(19) United States
(12) Patent Application Publication
(10) Pub. No.: US 2026/0249141 A1
(43) Pub. Date: Aug. 27, 2026

(54) GOLF CLUB HEAD AND METHOD FOR MAKING THE SAME

(71) Applicant: ADVANCED INTERNATIONAL MULTITECH CO., LTD., Kaohsiung City (TW)

(72) Inventors: Ming-Fu SU, Kaohsiung City (TW); Chun-Lu HUNG, Kaohsiung City (TW); Yen-Zhou XIE, Kaohsiung City (TW); Ta-I TSENG, Kaohsiung City (TW)

(21) Appl. No.: 19/181,442

(22) Filed: Apr. 17, 2025

(30) Foreign Application Priority Data
Feb. 25, 2025 (TW) 114106940

(51) Int. Cl. A63B 53/04; B29C 70/68; B29C 70/74; B29K 505/00; B29L 31/52; B33Y 80/00

(52) U.S. Cl. CPC A63B 53/04; B29C 70/682; B29C 70/745; A63B 2209/00; B29K 2505/00; B29L 2031/5227; B33Y 80/00

(57) ABSTRACT

A golf club head includes a club head main body and at least one counterweight block. The club head main body has at least one internal cavity that is in spatial communication with an external space through at least one opening. The at least one counterweight block is embedded in the at least one internal cavity. The at least one counterweight block has a cross-section dimension that is greater than a cross-section dimension of the at least one opening so that the at least one counterweight block is confined in the at least one internal cavity. The at least one counterweight block includes a plurality of metallic particles which are bonded to one another through a cured binding material. A method for making the golf club head is also provided.

### CROSS-REFERENCE TO RELATED APPLICATION

This application claims priority to Taiwanese Invention Patent Application No. 114106940, filed on Feb. 25, 2025, the entire disclosure of which is incorporated by reference herein.

### FIELD

The disclosure relates to ball equipment and a method for making the same, and more particularly to a golf club head including a counterweight block and a method for making the same.

### BACKGROUND

In order to improve the ball striking efficiency and hand feel during swing of golf clubs, many golf clubs are provided with counterweight blocks on the heads thereof to subtly adjust the center of gravity. Generally, blocky or ring-shaped counterweight blocks are fixed to the heads of the golf clubs by welding or screws. However, since the counterweight blocks and the heads are often made of dissimilar metals, they may not be welded together well; alternatively, costly brazing is required. Screw holes and assembly spaces on the heads are required for screwing the counterweight blocks to the heads. Besides, these pre-designed and manufactured counterweight blocks are often only suitable for corresponding heads, which is not universal. In other words, when manufactures want to release heads with different appearances, in addition to consideration of the aforementioned problems, the appearances of counterweight blocks have to be redesigned, which leads to frequent molding and difficult stock management, thereby increasing cost.

### SUMMARY

Therefore, an object of the disclosure is to provide a golf club head and a method for making the golf club head that can alleviate at least one of the drawbacks of the prior art.

According to a first aspect of the disclosure, the golf club head includes a club head main body and at least one counterweight block. The club head main body has at least one internal cavity that is in spatial communication with an external space through at least one opening of the club head main body. The at least one counterweight block is embedded in the at least one internal cavity. The at least one counterweight block has a cross-section dimension that is greater than a cross-section dimension of the at least one opening so that the at least one counterweight block is confined in the at least one internal cavity. The at least one counterweight block includes a plurality of metallic particles which are bonded to one another through a cured binding material.

According to a second aspect of the disclosure, the method for making the golf club head includes the steps of:
A) forming a club head main body which has at least one internal cavity in spatial communication with an external space through at least one opening of the club head main body;
B) simultaneously or separately introducing a plurality of metallic particles and a binding material into the at least one internal cavity through the at least one opening; and
C) curing the binding material inside the at least one internal cavity to form a cured binding material so that the plurality of metallic particles are bonded to one another through the cured binding material to form at least one counterweight block, the at least one counterweight block having a cross-section dimension that is greater than a cross-section dimension of the at least one opening.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating an embodiment of a method for making a golf club head according to the disclosure.

FIG. 2 is a sectional side view of a combination of a covering frame and a club head main body for being formed into the golf club head.

FIG. 3 is a top view of the club head main body shown in FIG. 2.

FIG. 4 is a sectional side view illustrating a plurality of metallic particles and a binding material being introduced into the club head main body.

FIG. 5 is a sectional side view illustrating the binding material being cured.

FIG. 6 is a bottom view of the golf club head made using the method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

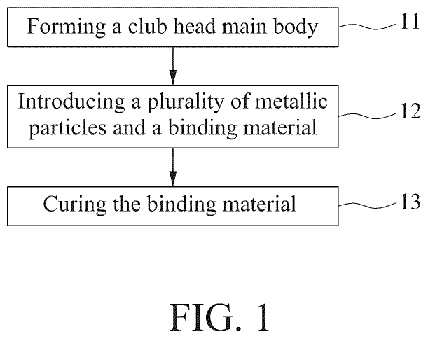

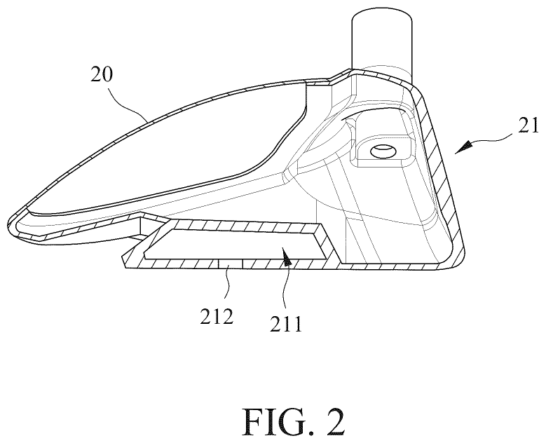

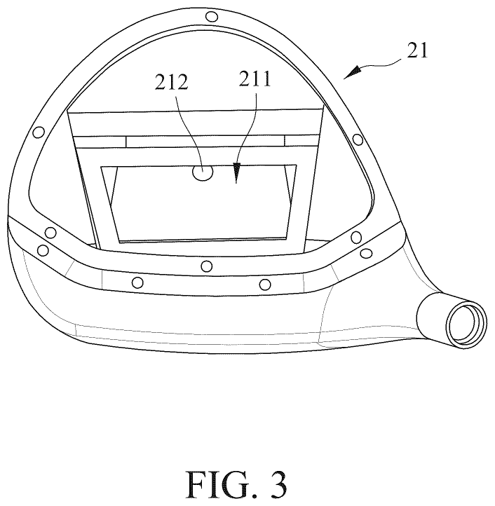

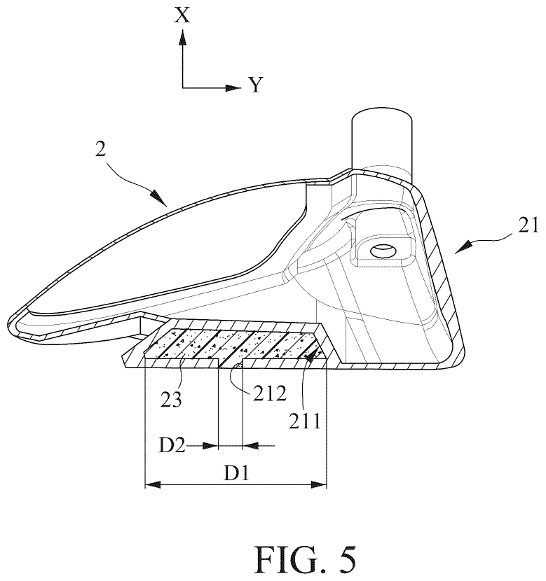

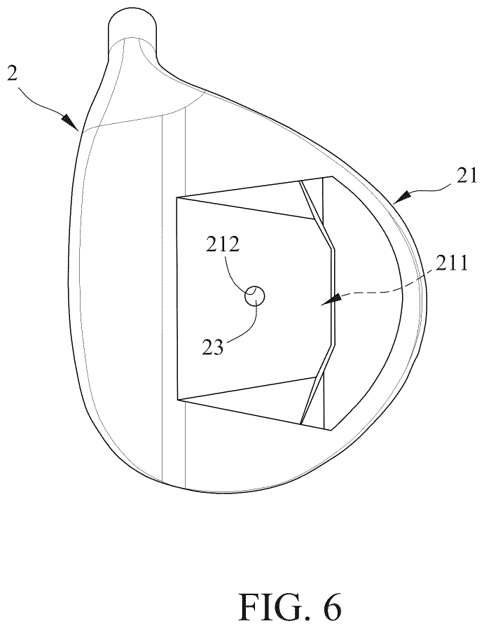

Referring to FIGS. 1, 2 and 3, an embodiment of a method for making a golf club head 2 shown in FIGS. 5 and 6 according to the present disclosure includes steps 11 to 13. In FIG. 2, a combination of a club head main body 21 and a covering frame 20 is shown. In step 11, the club head main body 21 shown in FIG. 3 is formed in one-piece without any interfaces or seams between sections thereof by casting, forging, additive manufacturing (i.e., 3D printing) or precision machining. The club head main body 21 has an internal cavity 211 in spatial communication with an external space through an opening 212 of the club head main body 21. Parameters regarding a contour of the internal cavity 211 may be quickly adjusted by computer-aided design and automated manufacturing to correspond to an actual shape and a center of gravity of the club head main body 21. It should be noted that a number of the internal cavity 211 may be plural, and a direction and a depth of the opening 212 may be determined according to a structure of the club head main body 21 and an actual position of the internal cavity 211 therein.

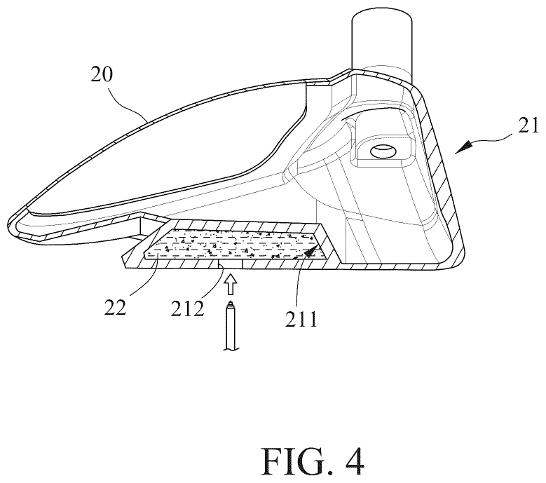

Referring to FIGS. 1 and 4, in step 12, a plurality of metallic particles and a binding material are mixed as a flowable introduced material 22. Materials of the plurality of metallic particles may be selected from metals with different densities (that is, the plurality of metallic particles may be made of the same metal or different metals) according to requirements, and the binding material may include or may be made of resin but is not limited to this aspect. A ratio of the plurality of metallic particles to the binding material in the introduced material 22 may be adjusted according to actual requirements. The introduced material 22 may be introduced into the internal cavity 211 through the opening 212 so as to fill the internal cavity 211 with the introduced material 22. That is, the plurality of metallic particles and the binding material are simultaneously introduced into the internal cavity 211 by introducing a mixture of the plurality of metallic particles and the binding material (i.e., the introduced material 22) into the internal cavity 211. Alternatively, the plurality of metallic particles may be introduced into the internal cavity 211 first before the binding material is introduced into the internal cavity 211, or the binding material may be introduced into the internal cavity 211 first before the plurality of metallic particles are introduced into the internal cavity 211. In other words, the plurality of metallic particles and the binding material may be simultaneously or separately introduced into the internal cavity 211 through the opening 212. When there are a plurality of internal cavities 211, the introducing material 22 may be introduced into the plurality of internal cavities 211 in sequence; in some embodiments, different introducing materials may be introduced into the plurality of internal cavities 211 respectively based on a required overall weight and a required center of gravity. Referring to FIGS. 1, 5 and 6, in step 13, the binding material of the introduced material 22 is cured by heating the internal cavity 211 (see FIG. 4) so as to form a counterweight block 23 which is embedded in the internal cavity 211. Specifically, the binding material is cured inside the internal cavity 211, so that the plurality of metallic particles are bonded to one another through the cured binding material, thereby forming the counterweight block 23. The counterweight block 23 is exposed from the club head main body 21 through the opening 212. The counterweight block 23 has a cross-section dimension (D1) that is greater than a cross-section dimension (D2) of the opening 212 so that the counterweight block 23 is confined in the internal cavity 211. Finally, the covering frame 20 is adhered to the club head main body 21 to obtain the golf head club 2 that includes the counterweight block 23.

As shown in FIG. 5, the opening 212 extends from an outer surface of the golf head club 2 to an inner surface of the internal cavity 211 along a first direction (X). In the cross-section view of the golf head club 2 shown in FIG. 5, the cross-section dimension (D2) of the opening 212 may refer to a width of the opening 212 measured in a second direction (Y) different from the first direction (X) (e.g., perpendicular to the first direction (X)). The cross-section dimension (D1) of the counterweight block 23 is a maximum dimension measured in the second direction (Y).

Since the counterweight block 23 is not fixed by welding or screws, poor welding quality, high cost due to brazing, reserved spaces for screws or problems of pre-designed counterweight blocks may be avoided. In addition, when the contour, type or structure of the club head main body 21 is altered, only parameters regarding the internal cavity 211 have to be adjusted by computer-aided design or automated manufacturing, so that the specific club head main body 21 with the specific internal cavity 211 may be formed in step 11. Regardless of the design of the internal cavity 211, the introduced material 22 can be used to make the counterweight block 23. Therefore, re-molding of the counterweight block 23 for new-released golf head clubs is prevented, which can greatly reduce unnecessary expenses. Furthermore, through material selection of the plurality of metallic particles and ratio adjustment of the introduced material 22, a precise weight and a precise center of gravity of the counterweight block 23 may be obtained. The method may also be used in a scenario where there are a plurality of internal cavities 211 and a plurality of counterweight blocks 23, which leads to high versatility and customized effects.

In summary, welding and screws are not required for the present disclosure, so that problems stated in the prior art may be avoided. Besides, the introduced material 22 may be used with the club head main bodies having different designs. Therefore, frequent molding and difficult stock management are prevented, which indeed achieves the object of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A golf club head, comprising:
a club head main body which has at least one internal cavity in spatial communication with an external space through at least one opening of said club head main body ; and
at least one counterweight block which is embedded in said at least one internal cavity, said at least one counterweight block having a cross-section dimension that is greater than a cross-section dimension of said at least one opening so that said at least one counterweight block is confined in said at least one internal cavity,
said at least one counterweight block including a plurality of metallic particles which are bonded to one another through a cured binding material.

2. The golf club head as claimed in claim 1, wherein said cured binding material in said at least one counterweight block includes resin.

3. The golf club head as claimed in claim 1, wherein said at least one counterweight block is exposed from said club head main body through said at least one opening.

4. The golf club head as claimed in claim 1, wherein said club head main body is formed in one-piece.

5. A method for making a golf club head, comprising the steps of:
A) forming a club head main body which has at least one internal cavity in spatial communication with an external space through at least one opening of the club head main body;
B) simultaneously or separately introducing a plurality of metallic particles and a binding material into the at least one internal cavity through the at least one opening; and
C) curing the binding material inside the at least one internal cavity to form a cured binding material so that the plurality of metallic particles are bonded to one another through the cured binding material to form at least one counterweight block, the at least one counterweight block having a cross-section dimension that is greater than a cross-section dimension of the at least one opening.

6. The method as claimed in claim 5, wherein, in step B), the plurality of metallic particles and the binding material are simultaneously introduced into the at least one internal cavity by introducing a mixture of the plurality of metallic particles and the binding material into the at least one internal cavity.

7. The method as claimed in claim 5, wherein in step B), the binding material includes resin.

8. The method as claimed in claim 5, wherein in step A), the at least one internal cavity in the club head main body is formed by casting, forging, additive manufacturing or precision machining.

9. The method as claimed in claim 5, wherein in step C), the binding material is cured by heating the at least one internal cavity so that the plurality of metallic particles are bonded to one another by the cured binding material, thereby forming the at least one counterweight block.
